(19) United States
(12) Patent Application Publication
(10) Pub. No.: US 2010/0307820 A1
(43) Pub. Date: Dec. 9, 2010

(54) ELECTRICAL CIRCUIT DEVICE, METHOD FOR MANUFACTURING THE SAME, AND METALLIC MOLD

(75) Inventors: Akinori Oishi, Yokkaichi-city (JP); Noriyuki Tani, Yokkaichi-city (JP); Yusuke Kikuchi, Yokkaichi-city (JP); Yuuji Saka, Yokkaichi-city (JP); Naoki Komura, Yokkaichi-city (JP); Yoshikazu Taniguchi, Yokkaichi-city (JP); Mitsuhiro Hattori, Yokkaichi-city (JP)

Correspondence Address: OLIFF & BERRIDGE, PLC, P.O. BOX 320850, ALEXANDRIA, VA, 22320-4850, US

(73) Assignee: SUMITOMO WIRING SYSTEMS, LTD., Yokkaichi-city, Mie (JP)

(21) Appl. No.: 12/864,670

(22) PCT Filed: Jul. 23, 2008
(86) PCT No.: PCT/JP2008/063190

§ 371 Date: Jul. 27, 2010

(30) Foreign Application Priority Data
Jan. 29, 2008 (JP) 2008-017482

(51) Int. Cl. H02G 3/00; B29C 70/72

(52) U.S. Cl. 174/70 R; 29/825; 425/117

(57) ABSTRACT

A manufacturing method includes wiring an electrical cable in a metallic mold, pouring molten resin into the metallic mold and solidifying the molten resin in the metallic mold to produce a wiring body module. The electrical cable is embedded in the solidified resin. The method further includes mounting an electrical component on the wiring body module.

### BACKGROUND

This invention relates to an electrical circuit device that is applied to a wire harness, an electrical junction box, or the like in a motor vehicle, a method for manufacturing the same, and a metallic mold.

An electrical circuit device in a motor vehicle or the like serves as an absorbing base for different standards between connection wirings, a connector relay base, a mounting base for various kinds of electrical components such as fuses and relays. Such electrical circuit device is used as an electrical junction box, a junction block, a relay box, a fuse box, or the like.

The electrical circuit device includes a press-out bus bar type structure and a PCB (Printed Circuit Board) type structure.

The press-out bus bar type structure is constructed by pressing out a thick metallic plate into a plurality of bus bars and laminating the bus bars to form a wiring pattern. The PCB type structure is constructed by using a PCB (Printed Circuit Board) as a circuit. The latter structure is suitable for mounting a semiconductor.

Prior arts relating to the exemplary embodiments of the present invention have been disclosed in, for example, JP 2000-139106 A, JP 2002-359349 A, and JP 2003-18725 A.

### SUMMARY

The electrical circuit device in the motor vehicle or the like has been required to highly respond to downsizing, saving a weight, setting a small pitch, facilitating a design change such as a circuit alteration, increasing a material yield and handling a high current.

However, the above two type structures are difficult to sufficiently respond to the above various requirements.

That is, since the press-out bus bar type structure is constructed by pressing out the thick metallic plate into a plurality of bus bars and laminating the bus bars to form a wiring pattern, it is difficult to downsize and save a weight. It is also difficult to set a small pitch of wiring on account of a dimension in width of the bus bar itself. It is also difficult to set a small pitch of connector terminals to be connected to the bus bar. Since the bus bar is produced by a pressing die and a large scale pressing machine, it is necessary to alter at least the pressing die itself so as to respond to a design change. Thus, it is difficult to speedily and readily respond to a design change at a low cost. Since the bus bar is formed by pressing out a thick metallic plate, there are wasted materials and this will lower a material yield.

Since the PCB type structure requires large scale manufacturing equipment for printing a conductive foil, it is difficult to speedily and readily respond to a design change such as a circuit alteration at a low cost. Also, since a thickness of the conductive foil is limited, the PCB type structure is not suitable for a high current circuit.

Accordingly, the exemplary embodiments allow for a quickly and efficiently responding to requirements for downsizing, saving a weight, setting a small pitch, facilitating a design change such as a circuit alteration, increasing a material yield and handling a high current.

In order to achieve these and other advantages, a method for manufacturing an electrical circuit device in a first exemplary embodiment, includes wiring an electrical cable in a metallic mold; pouring molten resin into the metallic mold and solidifying the molten resin in the metallic mold to produce a wiring body module in which the electrical cable is embedded in the solidified resin; and mounting an electrical component on the wiring body module.

Since the wired electrical cable forms an electrical circuit in the method for producing the electrical circuit device according to the exemplary embodiment, it is possible to downsize, save a weight, and set a narrow pitch in comparison with the case of forming an electrical circuit by the bus bar. It is possible to respond to a design change such as a circuit alteration merely by altering a wiring pattern of the electrical cable in the metallic mold. Further, since the electrical cable is wired in the metallic mold, a wasted electrical cable is hardly caused and thus a material yield is enhanced. Since the electrical cable forms the electrical circuit, the method is suitable for a high current circuit in comparison with the case of the PCB type structure that forms the circuit by the conductive foil. Accordingly, it is possible to highly respond to requirements for downsizing, saving a weight, setting a narrow pitch, facilitating a design change such as a circuit alteration, increasing a material yield, and handling a high current.

In a second exemplary embodiment, in the wiring an electrical cable in a metallic mold, positioning pins are provided in the metallic mold and the electrical cable is wired while positioning the electrical cable by the positioning pins.

Thus, it is possible to hold the wiring pattern of the electrical cable more positively by the positioning pins provided in the metallic mold.

In a third exemplary embodiment, the positioning pins are detachably provided in holes formed in the metallic mold.

Thus, it is possible to respond to a design change such as a circuit alteration more flexibly by detachably inserting the positioning pins into the holes formed in the metallic mold.

In a fourth exemplary embodiment, the positioning pins are provided at a position where the electrical component is mounted; and in the mounting an electrical component on the wiring body module, a connecting portion of the electrical component is inserted into a remaining hole formed by removing the positioning pin from the wiring body module and is electrically connected to the electrical cable to mount the electrical component on the wiring body module.

Thus, it is possible to readily mount the electrical component on the wiring body module by utilizing the remaining hole formed by removing the positioning pins so as to electrically connect the electrical cable to the connecting portion.

In a fifth exemplary embodiment, the remaining hole is formed in the wiring body module by removing the positioning pin therefrom, the remaining hole is formed so that when the connecting portion of the electrical component is inserted into the remaining hole, a part of the electrical cable exposed on an inner surface of the remaining hole and the connecting portion can be brought into pressurized contact with each other; and in the mounting an electrical component on the wiring body module, when the connecting portion of the electrical component is inserted into the remaining hole, the connecting portion is brought into pressurized contact with the part of the electrical cable exposed on the inner surface of the remaining hole, and the connecting portion and the electrical cable are coupled to each other.

Thus, since the connecting portion of the electrical component is inserted into the remaining hole, the connecting portion is brought into pressurized contact with a part of the electrical cable exposed on the inner surface of the remaining hole, and the connecting portion and electrical cable are coupled to each other, it is not necessary to provide an additional pressurizing means upon coupling them. Accordingly, it is possible to easily couple them.

In a sixth exemplary embodiment, in the producing a wiring body module, a part of the electrical cable to be connected to the electrical component is exposed outward from the wiring body module by a cable pressing member for pressing a part of the electrical cable to be connected to the electrical component so as to expose the part outward from the wiring body module or a projecting member that protrudes from a metallic mold surface of the metallic mold so as to expose a part of the electrical cable outward from the wiring body module.

Thus, since a part of the electrical cable to be connected to the electrical component is exposed outward from the wiring body module, it is easy to couple the electrical component and the electrical cable to each other upon mounting the electrical component on the wiring body module.

In a seventh exemplary embodiment, an electrical circuit device includes a wiring body module including an electrical cable wired in a given pattern in a metallic mold, a resin-molded section embedding the electrical cable wired in the given pattern in resin; and an electrical component mounted on the wiring body module.

Thus, since the wired electrical cable forms the electrical circuit, it is possible to downsize, save a weight, and set a narrow pitch in comparison with the case of the bus bar type structure that forms an electrical circuit by the bus bar. It is possible to respond to a design change such as a circuit alteration merely by altering a wiring pattern of the electrical cable. Further, since the electrical cable is wired in the metallic mold, a wasted electrical cable is hardly caused and thus a material yield is enhanced. Since the electrical cable forms the electrical circuit, the electrical circuit device of the seventh aspect is suitable for a high current circuit in comparison with the case of the PCB type structure that forms the electrical circuit by the conductive foil. Accordingly, it is possible to highly respond to requirements for downsizing, saving a weight, setting a narrow pitch, facilitating a design change such as a circuit alteration, increasing a material yield, and handling a high current.

In an eighth exemplary embodiment, the resin-molded section is provided with holes that can arrange positioning pins for positioning and holding the electrical cable in a given pattern.

Thus, it is possible to form the resin-molded section while holding the electrical cable in the given pattern by the positioning pins more positively.

In a ninth exemplary embodiment, a connecting portion of the electrical component is inserted into one of the holes that can arrange the positioning pins, the connecting portion is electrically connected to the electrical cable, and the electrical component is mounted on the wiring body module.

Thus, it is possible to readily mount the electrical component on the wiring body module by utilizing the remaining hole formed by removing the positioning pins so as to electrically connect the electrical cable to the connecting portion of the electrical component.

In a tenth exemplary embodiment, when the connecting portion of the electrical component is inserted into one of the holes that can arrange the positioning pin, a part of the electrical cable exposed on an inner surface of the hole and the connecting portion of the electrical component are brought into pressurized contact with each other to couple the connecting portion and the electrical cable to each other.

Thus, since the connecting portion of the electrical component is inserted into the remaining hole, the connecting portion is brought into pressurized contact with a part of the electrical cable exposed on the inner surface of the remaining hole, and the connecting portion and electrical cable are coupled to each other, it is not necessary to provide an additional pressurizing means upon coupling them. Accordingly, it is possible to easily couple them.

In an eleventh exemplary embodiment, the resin-molded section is provided with a recess that can contain a cable pressing member for pressing a part of the electrical cable to be connected to the electrical component so as to expose the part outward from the wiring body module or a projecting member that protrudes from a metallic mold surface of the metallic mold so as to expose a part of the electrical cable outward from the wiring body module.

Thus, since a part of the electrical wire to be connected to the electrical component is exposed outward from the wiring body module, it is possible to easily couple the electrical cable and the electrical component to each other upon mounting the electrical component on the wiring body module.

In a twelfth exemplary embodiment, a metallic mold device for manufacturing an electrical circuit includes a first metallic mold having a first metallic mold surface; and a second metallic mold having a second metallic mold surface; resin being molded in a space between the first and second metallic mold surfaces; positioning pins being provided on at least one of the first and second metallic mold surfaces to position wired electrical cable.

Thus, since the wired electrical cable forms an electrical circuit, it is possible to produce the electrical circuit device that can downsize, save a weight, and set a narrow pitch in comparison with the case of the bus bar type structure that forms an electrical circuit by the bus bar. Since the positioning pins can be displaced detachably so that the wiring pattern of the electrical cable is change in the metallic mold, it is possible to readily respond to a design change such as a circuit alteration. Further, since the electrical cable is wired in the metallic mold, a wasted electrical cable is hardly caused and thus a material yield is enhanced. Since the electrical cable forms the electrical circuit, the electrical circuit device of the twelfth aspect is suitable for a high current circuit. Accordingly, it is possible to produce the electrical circuit device that can highly respond to requirements for downsizing, saving a weight, setting a narrow pitch, facilitating a design change such as a circuit alteration, increasing a material yield, and handling a high current. It is also possible to positively hold the wiring pattern of the electrical cable by the positioning pins.

In a thirteenth exemplary embodiment, the positioning pins are detachably provided in holes formed in the metallic mold.

Thus, it is possible to flexibly respond to a design change such as a circuit alteration merely by detachably inserting the positioning pins into the holes in the metallic mold.

In a fourteenth exemplary embodiment, at least one of the first and second metallic mold surfaces is provided with a cable pressing member for pressing a part of the electrical cable to be connected to the electrical component so as to expose the part of the electrical cable outward from the resin-molded section or a projecting member that protrudes from the first metallic mold surface or the second metallic mold surface so as to expose a part of the electrical cable outward from the resin-molded section.

Thus, since a part of the electrical wire to be connected to the electrical component is exposed outward from the resin-molded portion, it is possible to easily couple the electrical cable and the electrical component to each other upon mounting the electrical component on the resin-molded portion.

The objects, features, aspects, and advantages of the present invention will be apparent from the following descriptions and the appended drawings.

### BRIEF DESCRIPTION OF THE DRAWINGS

FIG. 1 is a perspective view illustrating a schematic construction of an electrical circuit device;

FIG. 2 is a perspective view illustrating a schematic construction of the electrical circuit device;

FIG. 3 is a flow chart illustrating a method for manufacturing the electrical circuit device;

FIG. 4 is a schematic section view illustrating a metallic mold device;

FIG. 5 is a plan view of a lower metallic mold member of the metallic mold device;

FIG. 6 is a bottom plan view of an upper metallic mold member of the metallic mold device;

FIG. 7 is a schematic plan view illustrating a manner of wiring an electrical cable;

FIG. 8 is a schematic side elevation view illustrating a manner of wiring the electrical cable;

FIG. 9 is a schematic explanatory view illustrating a step of pouring and solidifying resin;

FIG. 10 is a schematic plan view illustrating a wiring body module;

FIG. 11 is an explanatory view illustrating a step of mounting a first connector terminal onto the wiring body module;

FIG. 12 is an explanatory view of illustrating an example of positioning a wired electrical cable by a plurality of positioning pins;

FIG. 13 is a section view illustrating the positioning pins and padding pins inserted in through-holes;

FIG. 14 is an explanatory view illustrating the electrical cable wired in a given pattern;

FIG. 15 is an explanatory view illustrating the electrical cable wired in an altered pattern; and

FIG. 16 is a section view illustrating an altered example in which a part of the electrical cable is exposed outward from the wiring body module.

### DETAILED DESCRIPTION OF EMBODIMENTS

Referring now to the drawings, embodiments an electrical circuit device, a method for manufacturing the same, and a metallic mold device in accordance with the exemplary embodiments will be described below.

### Brief Description of an Electrical Circuit Device

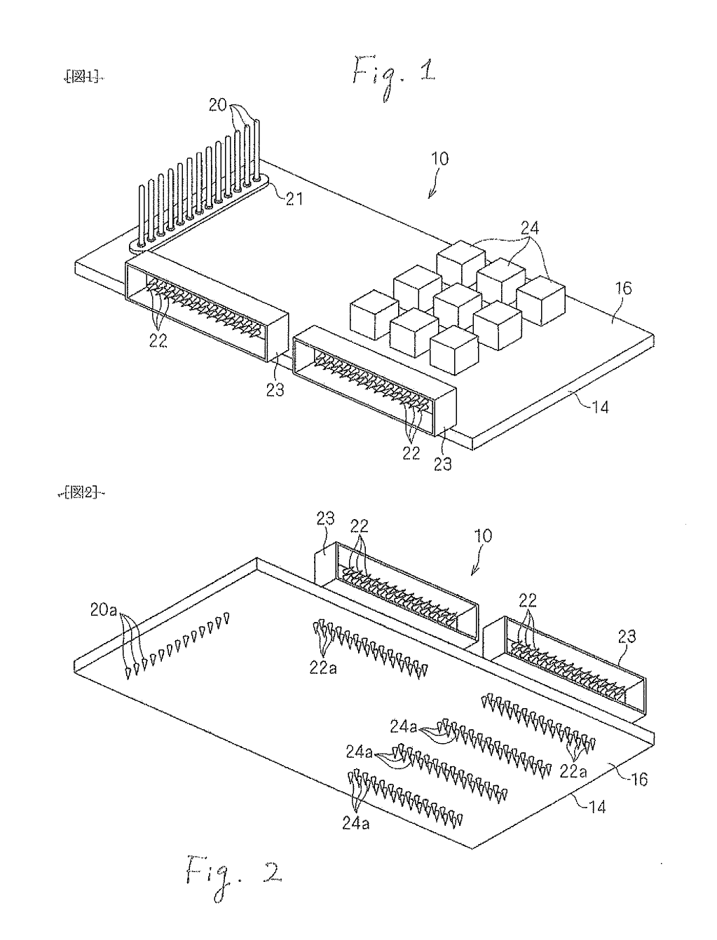

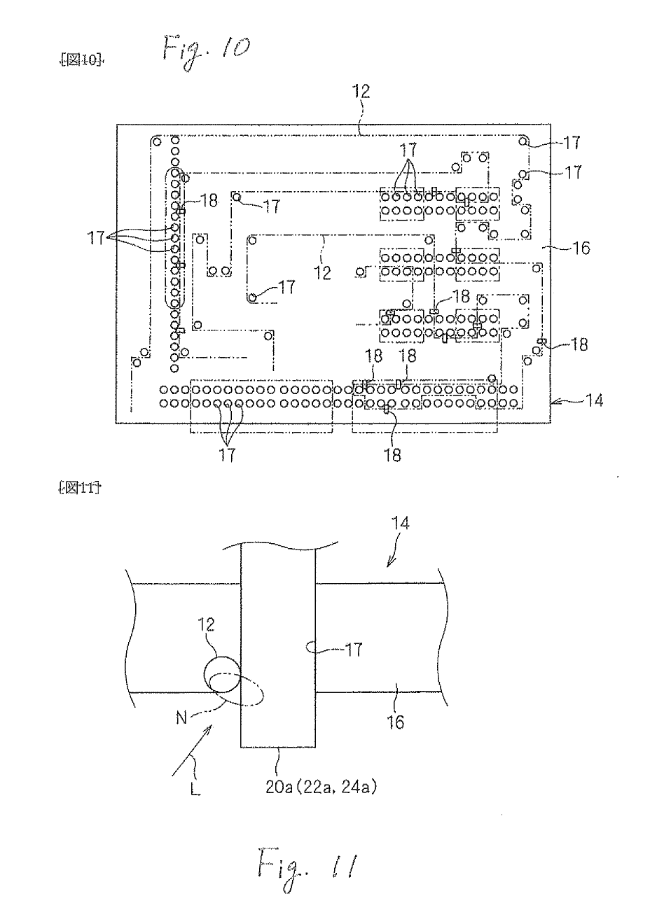

FIGS. 1 and 2 are perspective views illustrating a schematic construction of an electrical circuit device 10. The electrical circuit device 10 bears absorption of different standards (kinds of electrical cables and the like) between connecting wirings in a motor vehicle or the like, a function as a connector relay base that interconnects connecting wirings to one another by means of connector relay, and a function as a mounting base that mounts electrical components such as fuses, relays, semiconductors in a motor vehicle or the like. The electrical circuit device 10 can be used as a so-called electrical junction box, a so-called junction block, a so-called relay box, a so-called fuse box, a so-called electrical equipment unit, and the like. The electrical circuit device 10 includes a wiring body module 14, and electrical components 20, 22, and 24. The wiring body module 14 includes electrical cables 12 (not shown in FIGS. 1 and 2 but shown in FIG. 10) wired in a given pattern in a lower metallic mold member 40 mentioned after, and a resin-molded section 16 formed in a given configuration by a metallic mold (so-called molding) while embedding the electrical cables 12 in resin. The electrical components 20, 22, and 24 are connected to circuits on the electrical circuit device 10, are electrically connected to the electrical cables 12, and are mounted on the wiring body module 14. In the present embodiment, the electrical components 20, 22, and 24 are imagined as a plurality of first connector terminal portions 20 to be mounted on one side (here, a short side) of the wiring body module 14, as a plurality of second connector terminal portions 22 to be mounted on the other side (here, long side) of the wiring body module 14, and as element parts 24 such as power semiconductors to be mounted on an intermediate part of the wiring body module 14. The electrical components 20, 22, and 24 may be the other kinds of electrical components, for example, relays, fuses, control semiconductors, capacitors, resistances, and the like.

The electrical circuit device 10 is provided with holes 17 that can receive positioning pins 46 mentioned after (that is, the holes 17 are remaining holes formed by removing the positioning pins 46) and with recesses 18 that can receive cable pressing members 56 that expose parts of the electrical cables 12 outward (that is, the recesses 18 are remaining recesses formed by removing the cable pressing members 56). Although the holes 17 and recesses 18 are not shown in FIGS. 1 and 2, they are shown in FIG. 10.

### Manufacturing Method of the Electrical Circuit Device

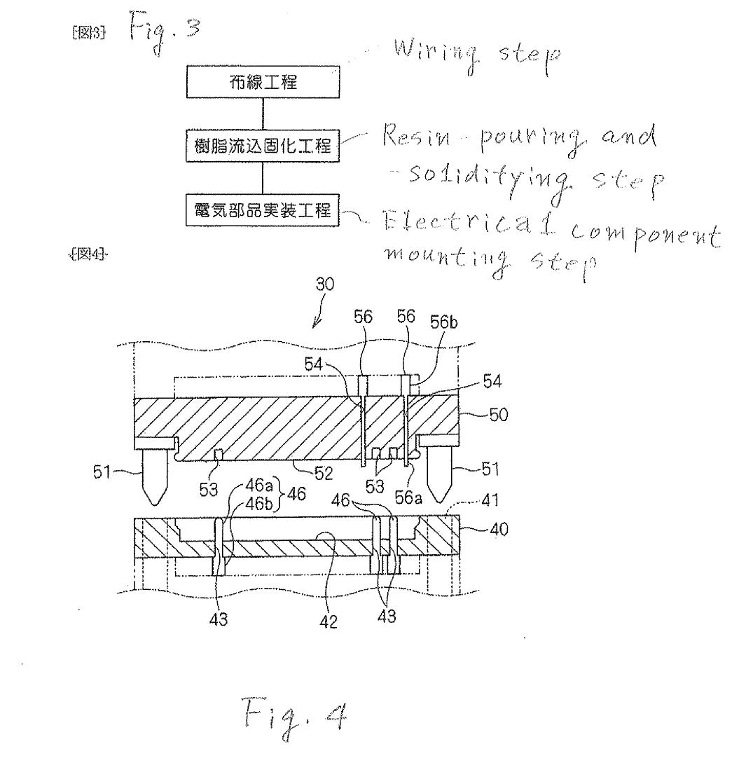

FIG. 3 is a flow chart illustrating a method for manufacturing the electrical circuit device 10. The method for manufacturing the electrical circuit device 10 includes the steps of: wiring an electrical cable 12 in the lower metallic mold member 40 (wiring step); pouring molten resin into a space between lower and upper metallic mold members 40 and 50 and solidifying the molten resin to produce the wiring body module 14 by (resin pouring and solidifying step); and mounting the electrical components 20, 22, and 24 on the wiring body module 14 (electrical component mounting step).

The above steps together with devices and the like to be used in the steps will be described below in order.

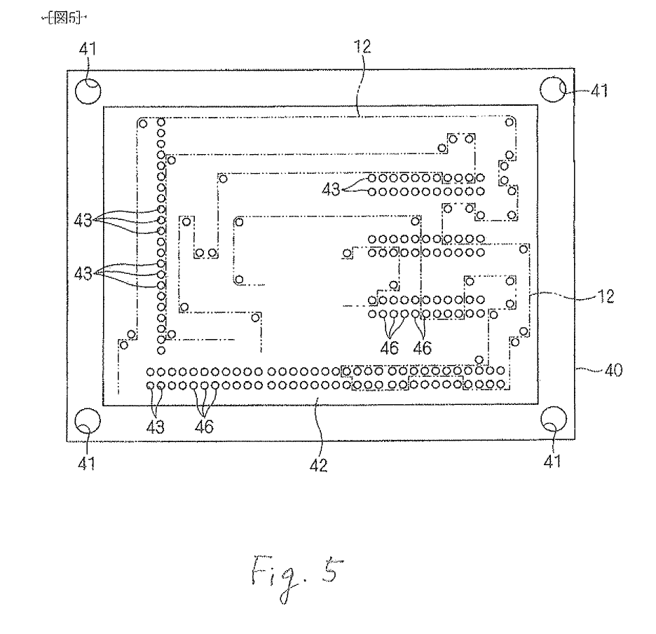

A metallic mold 30 includes a lower metallic mold member 40 and an upper metallic mold member 50. In the wiring step, the electrical cable 12 is wired in the lower metallic mold member 40. FIG. 4 is a schematic section view of the metallic mold device 30. FIG. 5 is a plan view of the lower metallic mold member 40 of the metallic mold device 30. FIG. 6 is a bottom plan view of the upper metallic mold member 50 of the metallic mold device 30.

The metallic mold device 30 includes the lower metallic mold member 40 as a first metallic mold and the upper metallic mold member 50 as a second metallic mold. The lower metallic mold member 40 is provided with a lower metallic mold surface 42 as a first metallic mold surface while the upper metallic mold member 50 is provided with an upper metallic mold surface 52 as a second metallic mold surface. Resin can be molded in a given shape between the lower and upper metallic mold surfaces 42 and 52. The lower metallic mold surface 42 is provided with a flat rectangular parallelepiped recess. The upper metallic mold surface 52 is formed into a flat rectangular shape that can close an upper opening in the recess of the lower metallic mold surface 42.

The lower metallic mold member 40 and upper metallic mold member 50 are disposed on a metallic mold moving mechanism (not shown) that can move them closely to and apart from each other. In the present embodiment, the lower metallic mold member 40 is attached to the metallic mold moving mechanism so that the lower metallic mold surface 42 is directed upward. The upper metallic mold member 50 is attached to the metallic mold moving mechanism so that the upper metallic mold surface 52 is directed downward and can be moved up and down above the lower metallic mold member 40. When the upper metallic mold surface 52 is moved down to approach the lower metallic mold surface 42, resin can be molded in a given shape (here, substantially rectangular shape) between the lower and upper metallic mold surfaces 42 and 52. When the upper metallic mold surface 52 is moved upward so as to separate from the lower metallic mold surface 42, a molded resin product can be removed from a space between the lower and upper metallic mold surfaces 42 and 52.

The lower metallic mold 40 is provided with guide holes 41 while the upper metallic mold 50 is provided with guide pins 51 adapted to be fitted in the guide holes 41. When the upper metallic mold 50 is moved down, the guide pins 51 are fitted into the guide holes 41 to position the lower and upper metallic mold surfaces 42 and 52.

Positioning pins 46 project upward on the lower metallic mold surface 42 to position the wired electrical cable 12 (see FIGS. 4 and 5).

Specifically, the lower metallic mold member 40 is provided with through-holes 43 extending from the lower metallic mold surface 42 to a rear side surface. Each positioning pin 46 is substantially formed into a stick-like configuration. More specifically, the positioning pin 46 includes a small diameter portion 46a that can pass the through-hole 43, and a large diameter portion 46b in which a diameter is greater than that of the small diameter portion 46a (see FIG. 4). When the small diameter portion 46a is inserted into the through-hole 43 from the rear side surface of the lower metallic mold surface 42 and the large diameter portion 46b is contacted with the rear side surface opposite from the lower metallic mold surface 42, a distal end of the small diameter portion 46a of the positioning pin 46 projects from the lower metallic mold surface 42 and the positioning pin 46 is detachably fixed in the through-hole 43.

An attachment structure of the positioning pin 46 is not limited to the above embodiment. The positioning pin 46 may be screwed into the through-hole 43 from the side of the lower metallic mold surface 42. The positioning pin 46 is not always detachably mounted in the through-hole 43. The positioning pin 46 may be secured to the lower metallic mold surface 42.

Also, a part of the small diameter portion 46a to be contained in the through-hole 43 may not be substantially the same cross section and size as those of a part of the portion 46a to be projected from the lower metallic mold surface 42. Particularly, as described after, the cross section or a size of the part of the positioning pin 46 that projects from the lower metallic mold surface 42 is suitably determined in accordance with a shape and a size of a part (connecting portions 20a, 22a, 24b) to be inserted into a remaining hole formed by removing the positioning pin 46.

The positioning pins 46 constructed above are arranged on the lower metallic mold member 40 so that the pins 46 can position the electrical cable 12 in accordance with wiring patterns of the cable 12 to be wired on the lower metallic mold surface 42.

Although the positioning pins 46 are arranged on the lower metallic mold surface 42 in the present embodiment, the positioning pins 46 may be arranged on the upper metallic mold surface 52, or the pins 46 may be arranged on both surfaces 42 and 52. In the case where the positioning pins 46 are arranged on the upper metallic mold surface 52, it is possible to position the electrical cables 12 wired on the upper metallic mold surface 52 more positively.

FIG. 5 shows a part of a wiring pattern of the electrical cable 12 wired on the lower metallic mold surface 42 by two-dot chain lines. The positioning pins 46 are arranged at positions that can position the electrical cable 12 to be wired on the lower metallic mold surface 42 along the desired wiring pattern, in particularly at positions inside curved portions of the desired wiring pattern. Thus, it is possible for the positioning pins to position the electrical cable 12 along the desired wiring pattern.

The positioning pins 46 are also arranged at the positions where the electrical cable 12 is disposed along the wiring patterns and the electrical components 20, 22, and 24 are mounted.

In the present embodiment, the positioning pins 46 are arranged at the position of the electrical component (first connector terminal) 20 to be mounted on one side of the wiring body module 14, at the position of the electrical component (second connector terminal) 22 to be mounted on the other side of the wiring body module 14, and at the position of the electrical component (element part) 24 to be mounted on the intermediate part of the wiring body module 14. The electrical cable 12 contacts the positioning pins 46 at the position where the cable 12 passes around the pins 46. Accordingly, a part of the electrical cable 12 is exposed in the remaining holes formed by removing the positioning pins 46 from the through-holes 43. As described after, the electrical cable 12 is electrically connected through the positioning pins 46 to the electrical components 20, 22, and 24 by utilizing the remaining holes formed by removing the pins 46.

The positioning pins 46 may be arranged at the positions where the electrical cable 12 can be wired along the wiring pattern imagined in design. In consideration of facilitation of mounting the electrical components 20, 22, and 24, the positioning pins 46 may be arranged at the positions to mount the components 20, 22, and 24. However, FIG. 5 shows that the positioning pins 46 are arranged at other positions as well as the positions along the wiring patterns imaged in design and the positions where the electrical components 20, 22, and 24 are mounted. Such additional pins 46 can be readily respond to a design change of a wiring pattern, and alteration of a kind or number of the electrical components 20, 22, and 24. This will be described after in detail.

FIG. 6 shows positions on the upper metallic mold surface 52 corresponding to a part of the wiring pattern of the electrical cable 12 wired on the lower metallic mold surface 42 by two-dot chain lines.

The upper metallic mold surface 52 is provided at positions corresponding to the positions of mounting the positioning pins 46 with holes 53 that can receive distal ends of the positioning pins 46. When the distal ends of the positioning pins 46 are inserted into the holes 53 upon fastening the metallic mold device, the holes 17 formed by the positioning pins 46 can surely penetrate the wiring body module 14.

The upper metallic mold surface 52 is provided with cable pressing portions 56 for pressing the electrical cable 12 so as to expose the portions of the electrical cable 12 connected to the electrical components 20, 22, and 24 outward from the resin-molded section 16 (see FIGS. 4 and 6).

More specifically, the upper metallic mold member 50 is provided with through-holes 54 extending from the upper metallic mold surface 52 to a rear side surface opposite from the surface 52. Each cable pressing portion 56 is substantially formed into a stick-like configuration. More specifically, the cable pressing portion 56 includes a small diameter portion 56a that can pass the through-hole 54, and a large diameter portion 56b in which a diameter is greater than that of the small diameter portion 56a. When the small diameter portion 56a is inserted into the through-hole 54 from the rear side surface opposite from the upper metallic mold surface 52 and the large diameter portion 56b is contacted with the rear side surface, a distal end of the small diameter portion 56a of the cable pressing portion 56 projects from the upper metallic mold surface 52 and the cable pressing portion 56 is detachably supported in the through-hole 54.

An attachment structure of the cable pressing portion 56 is not limited to the above embodiment. The cable pressing portion 56 may be screwed into the through-hole 54 from the upper metallic mold surface 52. The cable pressing portion is not always detachably mounted in the through-hole 54. The cable pressing portion 56 may be secured integrally to the upper metallic mold surface 52.

Also, a part of the small diameter portion 56a to be contained in the through-hole 54 may not be substantially the same cross section and size as those of a part of the portion 56a to be projected from the upper metallic mold surface 52. In the present embodiment, the part of the small diameter portion 56a projecting from the upper metallic mold surface 52 is formed into a flat plate-like configuration that extends in a direction perpendicular to an extending direction of the electrical cable 12 to be pressed.

A dimension of the cable pressing portion 56 projecting from the upper metallic mold surface 52 is set to expose the electrical cable 12 from one main plane of the wiring body module 14. In the present embodiment, the dimension is set to be a dimension in which a dimension in diameter of the electrical cable 12 is subtracted from a dimension in thickness of the wiring body module 14. When the cable pressing portions 56 press the electrical cable 12 wired on the lower metallic mold surface 42, portions (portions to be connected to the electrical components 20, 22, and 24) of the electrical cable 12 are exposed outward from the one main plane of the wiring body module 14 at the side of the lower metallic mold surface 42 (see FIGS. 9 and 11).

The cable pressing portion 56 may be provided on the lower metallic mold surface 42. This can readily mount the electrical components on the wiring body module 14 at the side of the lower metallic mold surface 42.

In the wiring step, the metallic mold device 30 described above is used and the electrical cable 12 is wired in the given pattern.

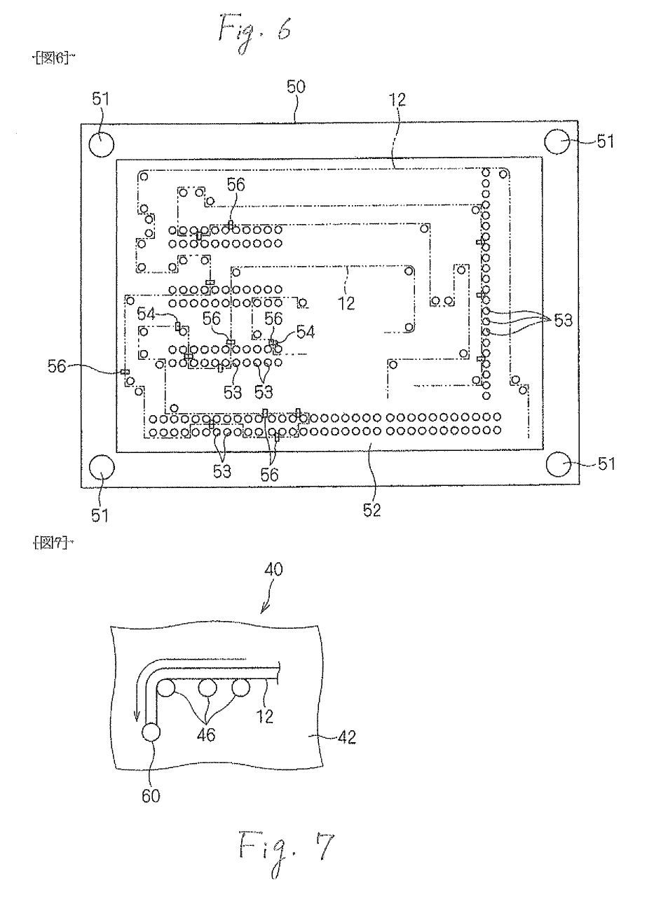

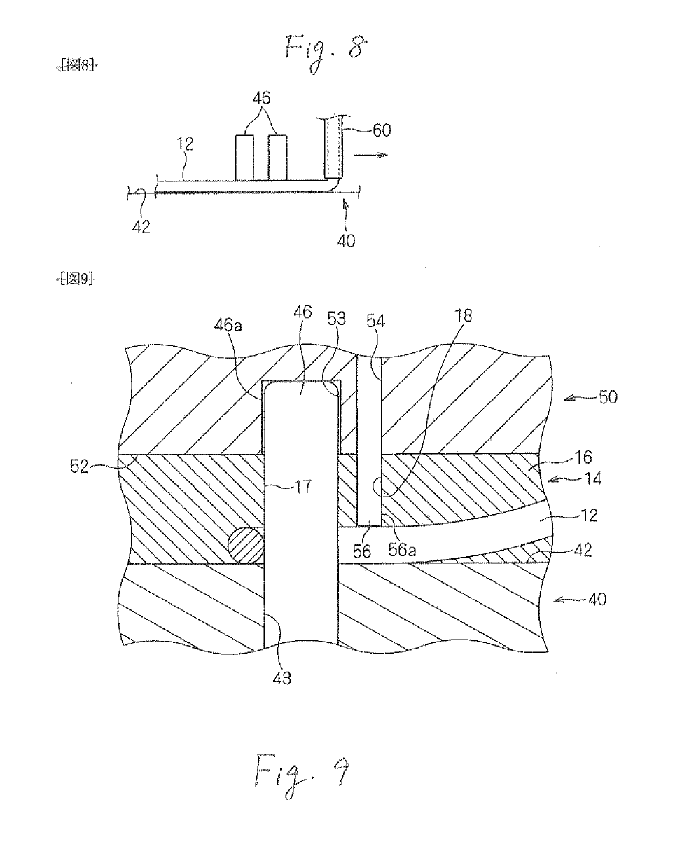

FIG. 7 is a schematic plan view illustrating a manner of wiring the electrical cable 12 on the lower metallic mold member 40. FIG. 8 is a schematic side elevation view illustrating a manner of wiring the electrical cable 12 on the member 40.

A wiring head 60 is disposed on the lower metallic mold surface 42 on which the positioning pins 46 are arranged. The wiring head 60 is movably supported by an X-Y displacement mechanism (not shown) or the like. The wiring head 60 continuously supplies the electrical cable 12 while the wiring head 60 is moving in lateral and longitudinal directions above the lower metallic mold surface 42 in accordance with a given wiring pattern in response to a circuit designed before hand. Such wiring apparatus can utilize various kinds of apparatuses including well known wiring apparatuses. Thus, the electrical cable 12 is wired on the lower metallic mold surface 42 in the given wiring pattern. At this time, the electrical cable 12 can be wired at the positions on which the positioning pins 46 are arranged while the electrical cable 12 is caught by the positioning pins 46. Accordingly, the electrical cable 12 can be positively held in the given positions.

The electrical cable 12 to be used in the present embodiment includes at least a conductive wire and preferably includes a wire coated with an insulation material such as an enamel wire. If the conductive wire is coated with an insulation material, it is possible to wire a plurality of electrical cables 12 in an intersecting or lapping manner without applying any additional insulating process.

After the electrical cables 12 are wired on the lower metallic mold surface 42, the resin pouring and solidifying step is carried out. FIG. 9 is a schematic explanatory view illustrating the resin pouring and solidifying step. In this step, after the upper metallic mold member 50 is approached to the lower metallic mold member 40 to fasten them, a resin supply nozzle (not shown) pours molten resin into a space between the lower and upper metallic mold surfaces 42 and 52 and the molten resin is solidified in the space.

When the electrical cable 12 is embedded in the resin-molded section 16, the electrical cable 12 is contacted with the positioning pins 46 so as to be caught by the pins 46. In the case where the cable pressing members 56 are disposed near the positioning pins 46, the cable pressing members 56 press the electrical cables 12 from the side of the upper metallic mold surface 52 to bring the electrical cable 12 into contact with the lower metallic mold surface 42. Accordingly, these portions of the electrical cable 12 are exposed in the remaining holes 17 formed by removing the positioning pins 46 and are also exposed on the main plane at the side of the lower metallic mold surface 42 of the wiring body module 14.

Thus, it is possible to obtain the wiring body module 14 in which the electrical cable 12 is embedded in the resin-molded section 16. FIG. 10 is a schematic plan view illustrating the wiring body module 14 manufactured by the above steps. In FIG. 10, the positions that mount the electrical cable 12 and electrical components 20, 22, and 24 are shown by two-dot chain lines. In the wiring body module 14, the resin-molded section 16 is provided with remaining holes 17 formed by removing the positioning pins 46 and with the recesses 18 with bottom walls formed by removing the cable pressing members 56.

The whole electrical cable 12 is not always embedded in the resin-molded section 16. The electrical cable 12 is partially embedded in the resin-molded section 16. In brief, the electrical cable 12 may be embedded in the resin-molded section 16 so as to maintain the electrical cable 12 in the given wiring pattern. In the case where the electrical cable 12 is molded by the above steps, the electrical cable 12 is brought into close contact with the resin-molded section 16. This structure is different from the case where the electrical cable 12 is wired after forming the resin molding product.

After the wiring body module 14 is manufactured by the above steps, the electrical component mounting step is carried out. In the electrical component mounting step, the electrical components 20, 22, and 24 are mounted on the wiring body module 14 by utilizing the remaining holes 17 formed by removing the positioning pins 46.

The electrical components (first connector terminals) 20 are gathered in a given arrangement (here, are separated by a given distance on a line) by a resin section 21 or the like (see FIG. 1). A connecting portion 20a (see FIG. 2) at a proximal end of each of the first connector terminals 20 is inserted into the remaining hole 17 provided in the wiring body module 14 at a predetermined position to mount the first connector terminal 20. FIG. 11 is an explanatory view illustrating a step of mounting the first connector terminal 20 onto the wiring body module 14. As shown in FIG. 11, a part of the electrical cable 12 is exposed in the remaining hole 17 formed in the wiring body module 14. The other part of the electrical cable 12 is exposed on the main plane (here, an opposite side surface from the plane mounting the electrical components 20, 22, 24) of the wiring body module 14 by the cable pressing member 56. The positioning pin 46 that forms the remaining hole 17 has the substantially same shape and size as those of the connecting portion 20a or slightly smaller shape (here, in the illustrated embodiment) than that of the connecting portion 20a. When the connecting portion 20a is inserted into the remaining hole 17, the electrical cable 12 exposed in the remaining hole 17 and the connecting portion 20a can be brought into pressurized contact with each other.

As described above, the connecting portion 20a is inserted into the remaining hole 17 to electrically interconnect the connecting portion 20a and the electrical cable 12 exposed in the remaining hole 17 to each other. A coupling manner between the electrical cable 12 and the connecting portion 20a can adopt laser welding, resistance welding, soldering, or the like. Particular, the laser welding is preferable.

Since the electrical cable 12 and connecting portion 20a are brought into pressurized contact with each other, it is possible to carry out the coupling work without providing any additional work pressurizing means or the like. Since a part of the electrical cable 12 is exposed on the main plane of the wiring body module 14, it is possible to relatively readily carry out the coupling work for a contacting portion between the electrical cable 12 and the connecting portion 20a. An area N shown by a two-dot chain line in FIG. 11 designates a welding nugget N.

In the case where a material that can be removed at the same time as the coupling work is used as an insulation coating for the electrical cable 12, the coating removing work and the coupling work can be carried out at a time by the coupling work. In the case where a material that cannot be removed at the same time as the coupling work is used as an insulation coating for the electrical cable 12, the coupling work is carried out after finishing the coating removing work (laser radiating work capable of removing the coating).

The electrical components (second connector terminals) 22 are assembled in connector housings 23 each having a given configuration and are gathered in a given arrangement. A connecting portion 22a at a proximal end of the second connector terminal 22a is inserted into the remaining hole 17 in the wiring body module 14 and is coupled to each other, as is the case with the connecting portion 20a. Thus, the second connector terminal 22a is mounted on the wiring body module 14 (see FIGS. 1 and 2).

The electrical components (element parts) 24 have connecting portions (so-called lead terminals) 24a. The element parts 24a are mounted on the wiring body module 14, as is the case with the connecting portions 20a and 22a (see FIGS. 1 and 2).

Thus, the electrical circuit device 10 is manufactured by mounting the electrical components 20, 22, and 24 on the wiring body module 14.

Since the electrical cable 12 constitutes the circuit by the manufacturing method of the electrical circuit device 10, the electrical circuit device 10, the metallic mold device 30 constructed by the above steps, it is possible to downsize, to save a weight, and to set a narrow pitch in comparison with the prior art that includes a bus bar circuit.

Since the wiring pattern of the electrical cable 12 is easily altered on the wiring body mold 14, such alteration of the wiring pattern can respond to a design change such as a circuit alteration more easily in comparison with a manner of forming a circuit by a bus bar or a manner of forming a circuit by a conductive foil maid of a PCB. Such effect can be obtained even if the arrangement of the positioning pins cannot be altered and is determined in accordance with a wiring pattern designed in an original stage in the positioning construction of the electrical cable 12 by means of the positioning pins 46. Even if such occasion is caused, it is possible to easily alter the wiring pattern of the electrical cable 12 without using the positioning pins 46 provided initially within a range of the positions of the positioning pins 46, or by catching the other electrical cable 12 by the positioning pins 46 provided initially.

Since the electrical cable 12 is wired to form an electrical circuit, any wasted electrical cable is hardly caused and a material yield is enhanced.

Further, since the electrical cable 12 constitutes the electrical circuit, it is possible to form an electrical circuit suitable for a high electrical current in comparison with the PCB type structure in which the electrical circuit is made of a conductive foil.

Thus, it is possible to respond to requirement for material yield and high current ability at a level as high as possible by getting ready for a design change such as a circuit alteration, downsizing, saving a weight, setting a pitch.

It is possible to form the resin-molded section while maintaining the wiring state of the electrical cable 12 in more reliability by the positioning pins 46 provided on the lower metallic mold surface 42.

Since the electrical components 20, 22, and 24 are mounted on the wiring body module 14 so that the connecting portions 20a, 22a, and 24a of the electrical components 20, 22, and 24 are electrically connected to the electrical cable 12 by utilizing the remaining holes 17 formed by removing the positioning pins 46, the electrical components 20, 22, and 24 can be readily mounted on the wiring body module 14. Thus, it is possible to easily realize extension of function (extension of function in the electrical circuit device 10) by means of the electrical components 20, 22, and 24. Particularly, although the prior art structure that uses bus bars has been difficult to mount electrical components (optimized semiconductors) on, in particular, a PCB, the present invention can mount the semiconductors on the wiring body module by adopting the wiring structure of the electrical cable 12 and utilizing the remaining holes formed by the positioning pins.

When the connecting portions 20a, 22a, and 24a of the electrical components 20, 22, and 24 are inserted into the remaining holes 17 and are brought into pressurized contact with the electrical cables 12 exposed in the remaining holes 17, the coupling work between the connecting portions 20a, 22a, and 24a and the electrical cables 12 are carried out. Accordingly, it is possible to carry out the coupling work without providing any additional pressurizing step.

Further, since the portions of the electrical cable 12 to be connected to the electrical components 20, 22, and 24 are exposed outward from the wiring body module 14 by the cable pressing members 56, it is possible to carry out radiation of laser beams to the contacting portions between the connecting portions 20a, 22a, and 24a of the electrical components 20, 22, and 24 and the electrical cable 12, thereby easily carrying out the coupling work of them.

### Modified Example

The positioning pins 46 may be arranged at the other positions in addition to the positions where the electrical cable 12 is disposed along the wiring pattern to be imagined in design (positions for mounting the electrical components 20, 22, and 24, as required). In this case, the positioning pins may be arranged in suitably dispersed positions. FIG. 12 illustrates an example of the positioning pins 46 arranged in a plurality of lateral and longitudinal lines. In this case, it is possible to arrange the electrical cable 12 along the given wiring pattern (the electrical cable 12 shown by a solid line in FIG. 12) while utilizing and positioning at least one of the plural positioning pins 46 in accordance with the wiring pattern of an electrical circuit imagined initially. If the wiring patterns are altered by a design change, it is possible to arrange the electrical cable 12 along the altered, given wiring pattern (the electrical cable 12 shown by a tow-dot chain line in FIG. 12) while utilizing and positioning at least one selected out of the plural positioning pins 46 in accordance with the altered wiring pattern of the electrical circuit imagined initially. Thus, it is possible to flexibly respond to the case where the wiring pattern is altered by a design change.

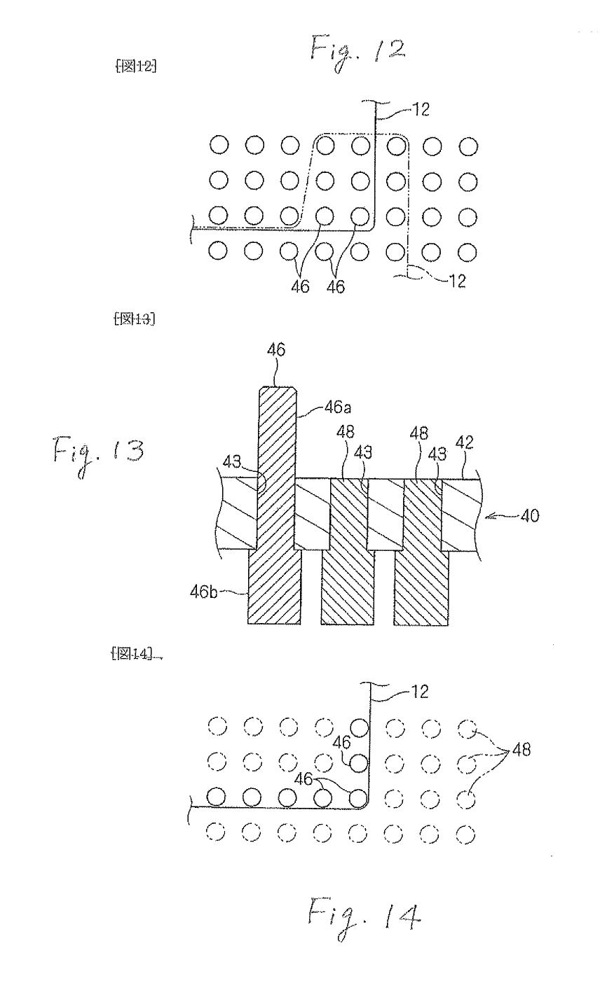

The positioning pins 46 may be detachably arranged on the wiring body module 14 in accordance with the altered wiring pattern. As shown in FIG. 13, the respective positioning pins 46 are detachably inserted into and held in the through-holes 43 in the lower metallic mold member 40. The through-holes 43 are redundantly provided at the other positions in addition to the positions that can dispose the positioning pins 46 along the wiring pattern imagined in design (also the positions for mounting the electrical components 20, 22, and 24, as required). The positioning pins 46 are attached to the positions that can dispose the electrical cable 12 along the wiring pattern imagined in design (the positions for mounting the electrical components 20, 22, and 24, as required). Padding pins 48 are embedded in the unnecessary through-holes 43. A portion of each padding pin 48 out of the positioning pins 46 projecting from the lower metallic mold surface 42 is cut off. When the padding pin 48 is inserted into the through-hole 43, the unnecessary through-hole 43 is embedded to make the same plane on the lower metallic mold surface 42.

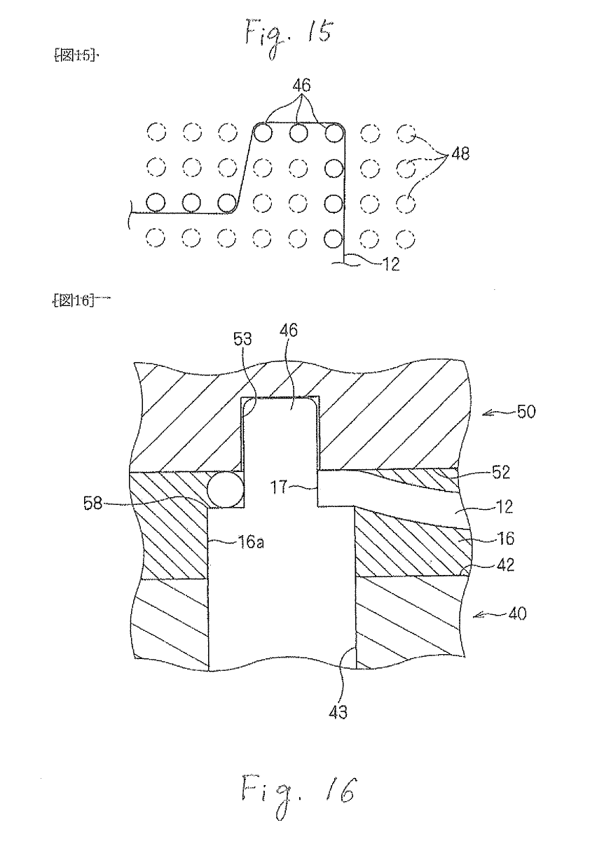

Thus, as shown in, for example, FIG. 14, the positioning pins 46 are arranged in the positions for disposing the electrical cable 12 in the given wiring pattern, the redundant positioning pins 46 are removed, and the electrical cable 12 is held in the given position. In FIGS. 14 and 15, a solid line designates the positioning pins 46 and a two-dot chain line designates each padding pins 48.

On the other hand, if the wiring pattern must be altered on account of a design change, the positioning pins 46 and padding pins 48 are inserted into and removed from the holes 43 and 48 in accordance with the altered wiring pattern. Thus, as shown in, for example, FIG. 15, the positioning pins 46 are arranged in the positions for disposing the electrical cable 12 in the altered wiring pattern, the redundant positioning pins 46 are removed, and the electrical cable 12 is held in the given position.

The above manner can be applied to alterations of mounting positions, kinds, and addition of the electrical components 20, 22, and 24 as well as the alteration of the wiring pattern.

The positioning pins 46 or the through-holes 43 may be provided additionally at the positions where additional electrical components 20, 22, and 24 are supposed to be mounted. The positioning pins 46 or the through-holes 43 may be provided additionally at the other positions ready for alteration of the wiring pattern.

The cable pressing members 56 may be provided additionally at unnecessary positions or they are detachably provided in accordance with the wiring patterns.

Sizes, shapes and the like of all positioning pins 46 and through-holes 43 may be substantially same. The positioning pins 46 for positioning the electrical cable 12 are different from the positioning pins for mounting the electrical components 20, 22, and 24. In particular, sizes and shapes of the portions of the positioning pins 46 projecting from the lower metallic mold surface 42 may be formed in accordance with those of the connecting portions 20a, 22a, and 24a of the electrical components 20, 22, and 24.

FIG. 16 shows an alteration that exposes a part of the electrical cable 12 outward from the wiring body module 14. As shown in FIG. 16, a projecting member 58 in lieu of the cable pressing member 56 may be provided on the lower metallic mold surface 42 at the positions where the electrical cable 12 is connected to the electrical components 20, 22, and 24. In the present embodiment, the projecting member 58 is formed by making a diameter of a proximal end of the positioning pin 46 projecting from the lower metallic mold surface 42 greater than that of a distal end of the pin 46. Thus, the resin-molded section 16 is concaved to define a recess 46a at the remaining hole formed by removing the positioning pin 46. The electrical cable 12 is partially exposed in an inner part in the recess 46a, thereby exposing the part of the electrical cable 12 outward from the wiring body module 14. Thus, it is possible to readily interconnect the connecting portions 20a, 22a, and 24a of electrical components 20, 22, and 24 and the cable 12 to each other.

Wiring members such as other jumper wires may be used in the electrical circuit device 10 together with the electrical cable 12.

The above described embodiments and alterations thereof may be suitably combined with other embodiments unless contradictions would render the discussed embodiments unusable.

Although the method for manufacturing the electrical circuit device, the electrical circuit device, and the metallic mold device are described above in detail, these descriptions are merely examples and the present invention is not limited to these examples. Various examples that are not described here will be contained in the present invention without departing the spirit of the present invention.

1-14. (canceled)

15. A method for manufacturing an electrical circuit device, comprising the steps of:
wiring an electrical cable in a metallic mold;
pouring molten resin into the metallic mold and solidifying the molten resin in the metallic mold to produce a wiring body module in which the electrical cable is embedded in the solidified resin; and
mounting an electrical component on the wiring body module.

16. The method for manufacturing an electrical circuit device, according to claim 15, wherein in the step of wiring an electrical cable in a metallic mold, positioning pins are provided in the metallic mold and the electrical cable is wired while positioning the electrical cable by the positioning pins.

17. The method for manufacturing an electrical circuit device, according to claim 16, wherein the positioning pins are detachably provided in holes formed in the metallic mold.

18. The method for manufacturing an electrical circuit device, according to claim 16, wherein the positioning pins are provided at a position where the electrical component is mounted; and
wherein in the step of mounting an electrical component on the wiring body module, a connecting portion of the electrical component is inserted into a remaining hole formed by removing the positioning pin from the wiring body module and is electrically connected to the electrical cable to mount the electrical component on the wiring body module.

19. The method for manufacturing an electrical circuit device, according to claim 18, wherein the remaining hole is formed so that when the connecting portion of the electrical component is inserted into the remaining hole, a part of the electrical cable exposed on an inner surface of the remaining hole and the connecting portion can be brought into pressurized contact with each other; and
wherein in the step of mounting an electrical component on the wiring body module, when the connecting portion of the electrical component is inserted into the remaining hole, the connecting portion is brought into pressurized contact with the part of the electrical cable exposed on the inner surface of the remaining hole, and the connecting portion and the electrical cable are coupled to each other.

20. The method for manufacturing an electrical circuit device, according to claim 15, wherein in the production of the wiring body module, a part of the electrical cable to be connected to the electrical component is exposed outward from the wiring body module by a cable pressing member for pressing a part of the electrical cable to be connected to the electrical component so as to expose the part outward from the wiring body module or a projecting member that protrudes from a metallic mold surface of the metallic mold so as to expose a part of the electrical cable outward from the wiring body module.

21. An electrical circuit device comprising:
a wiring body module including an electrical cable wired in a given pattern in a metallic mold, the metallic mold having a metallic mold surface;
a resin-molded section, the electrical cable wired in the given pattern being embedded in resin of the resin-molded section; and
an electrical component mounted on the wiring body module.

22. The electrical circuit device according to claim 21, wherein the resin-molded section defines holes configured for positioning pins for positioning and holding the electrical cable in a given pattern.

23. The electrical circuit device according to claim 22, wherein the electrical component includes a connecting portion that is inserted into one of the holes, the connecting portion being electrically connected to the electrical cable, and the electrical component being mounted on the wiring body module.

24. The electrical circuit device according to claim 23, wherein when the connecting portion of the electrical component is inserted into one of the holes configured for a corresponding positioning pin, a part of the electrical cable exposed on an inner surface of the corresponding hole and the connecting portion of the electrical component are brought into pressurized contact with each other to couple the connecting portion and the electrical cable to each other.

25. The electrical circuit device according to claim 21, further comprising:
a projecting member that protrudes from the metallic mold surface of the metallic mold, wherein:
the resin-molded section has a recess configured to accept a cable pressing member for pressing a part of the electrical cable to be connected to the electrical component so as to expose the part outward from the wiring body module or the projecting member so as to expose a part of the electrical cable outward from the wiring body module.

26. The metallic mold device for manufacturing an electrical circuit device, comprising:
a first metallic mold having a first metallic mold surface; and
a second metallic mold having a second metallic mold surface;
resin being molded in a space between the first and second metallic mold surfaces;
positioning pins being provided on at least one of the first and second metallic mold surfaces to position wired electrical cable.

27. The metallic mold device according to claim 26, wherein the positioning pins are detachably provided in holes defined by the first and second metallic molds.

28. The metallic mold device according to claim 26, further comprising:
an electrical component;
a projecting member that protrudes from the second metallic mold surface of the second metallic mold; and
a cable pressing member that presses a part of the electrical cable to be connected to the electrical component so as to expose the part of the electrical cable outward from the resin-molded section or the projecting member.
